(19) United States
(12) Patent Application Publication
(10) Pub. No.: US 2017/0330491 A1
(43) Pub. Date: Nov. 16, 2017

(54) Event display board

(71) Applicants: Mary Megan Koludrovic, Elmhurst, IL (US); Anthony Mark Koludrovic, Elmhurst, IL (US)

(72) Inventors: Mary Megan Koludrovic, Elmhurst, IL (US); Anthony Mark Koludrovic, Elmhurst, IL (US)

(21) Appl. No.: 15/588,995

(22) Filed: May 8, 2017

Related U.S. Application Data
(60) Provisional application No. 62/335,182, filed on May 12, 2016.

(51) Int. Cl. G09F 11/04; G09F 15/00

(52) U.S. Cl. CPC G09F 11/04; G09F 15/0056; G09F 15/0087

(57) ABSTRACT

An event display board for displaying important events in a person's life is disclosed. The display board comprises of combinations of words and numbers printed on wheels and viewable through display windows. The words or numbers displayed through the windows may be changed by rotating the wheels until the desired words or numbers show through the display windows and the words or numbers on each wheel line up with corresponding words or numbers on adjacent wheels to form phrases appropriate for the event so they can be displayed and photographed.

### RELATED APPLICATIONS

This application claims priority from provisional application 62/335,182 filed on May 12, 2016.

### FIELD OF THE INVENTION

The present invention relates to an event display board made of a combination of words and numbers disposed on wheels and viewable through display windows. The words or numbers displayed through the windows may be changed by rotating the wheels until the desired words or numbers show through the display windows and until the words or numbers on each wheel line up with corresponding words or numbers on adjacent wheels to form phrases appropriate for the event so they can be displayed and photographed.

More specifically, an embodiment of the present invention relates to a board configured for displaying the age of an infant or toddler. The board is placed next to the child when the child is photographed. Another embodiment of the present invention represents a board configured for displaying a day event in a child's life, such as a first day of school or last day of kindergarten.

### BACKGROUND OF THE INVENTION

Dating paper and digital photographs at the time when the photos are taken is only done infrequently by most people. Photographs are often taken in a hurry and as an afterthought and dating the photos tends to come after significant passage of time when the memories are not as fresh. Therefore, it would be desirable to provide a display that can be set up in a short period of time next to the object being photographed that would provide information about the date the photo was taken as well as other desirable information to have, such as the age of the person.

### SUMMARY OF THE PRESENT INVENTION

In one aspect of the present invention, a board for displaying events comprises a front panel; a rear panel; and a wheel assembly containing a plurality of wheels disposed between the front panel and the rear panel, with each wheel being attached to the front panel and a rear panel at a center of each wheel and with each wheel being configured to rotate around its center.

In another aspect of the present invention, a method for setting up and displaying the event board that contains a wheel assembly of five wheels comprises: rotating the first wheel and the second wheel in such a manner as to arrange the labels on the first wheel to align with corresponding labels on the second wheel; rotating the third wheel and the fourth wheel in such a manner as to arrange the labels on the third wheel to align with corresponding labels on the fourth wheel; and rotating the fifth wheel in such a manner as to arrange the labels on the fifth wheel with corresponding labels on the third wheel.

These and other features, aspects and advantages of the present invention will become better understood with reference to the following drawings, description and claims.

### BRIEF DESCRIPTION OF THE DRAWINGS

FIGS. 1 and 2 are front views of an event display board according to a first embodiment of the present invention;

FIG. 3 shows a rear view of the event display board according to the first embodiment of the present invention;

FIG. 4 represents a rear sectional view of the event display board according to the first embodiment of the present invention;

FIG. 5 illustrates a side perspective view of the event display board according to the first embodiment of the present invention;

FIG. 6 illustrates a rear perspective view of the event display board according to the first embodiment of the present invention;

FIG. 7 depicts components of the event display board according to the first embodiment of the present invention;

FIG. 8 illustrates a front sectional view of the event display board according to the first embodiment of the present invention;

FIG. 9 portrays another front sectional view of the event display board according to the first embodiment of the present invention;

FIG. 10 illustrates a front sectional view of the event display board according to a second embodiment of the present invention;

FIG. 11 is another front sectional view of the event display board according to the second embodiment of the present invention;

FIG. 12 is a front view of the event display board according to the second embodiment of the present invention; and

FIG. 13 illustrates a rear sectional view of the event display board according to the second embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

It is the object of the present invention to provide a board that quickly displays information about an object being photographed to record the information for posterity. It is also the object of the present invention to provide a board configured for quickly displaying the age of a child and the date the photo is taken, and for quickly setting up the board next to the child before the photo is taken.

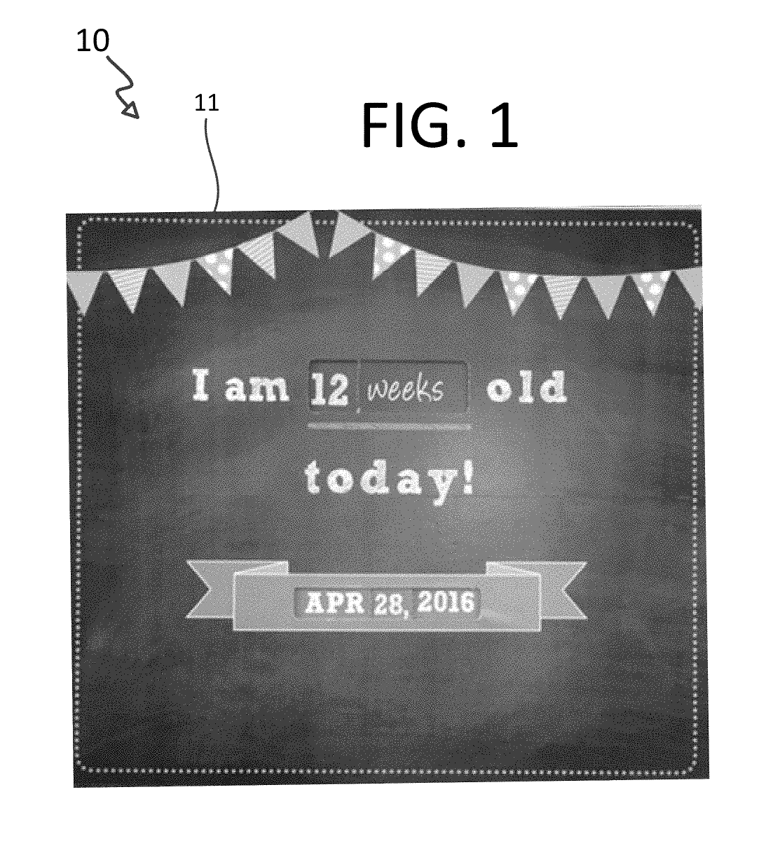

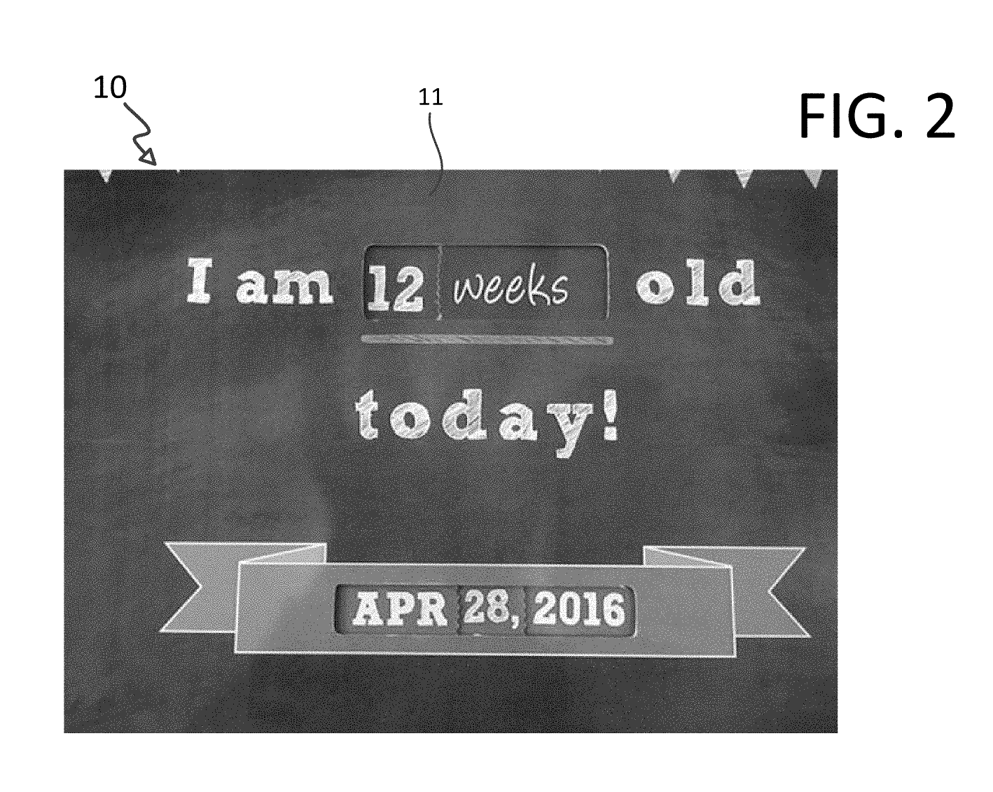

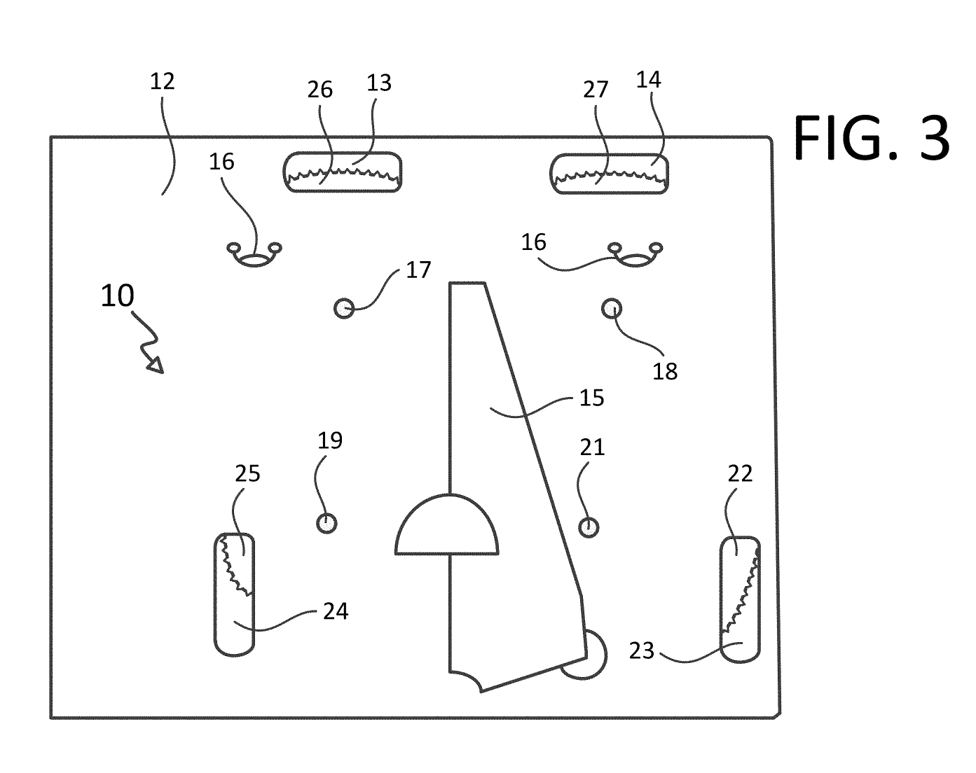

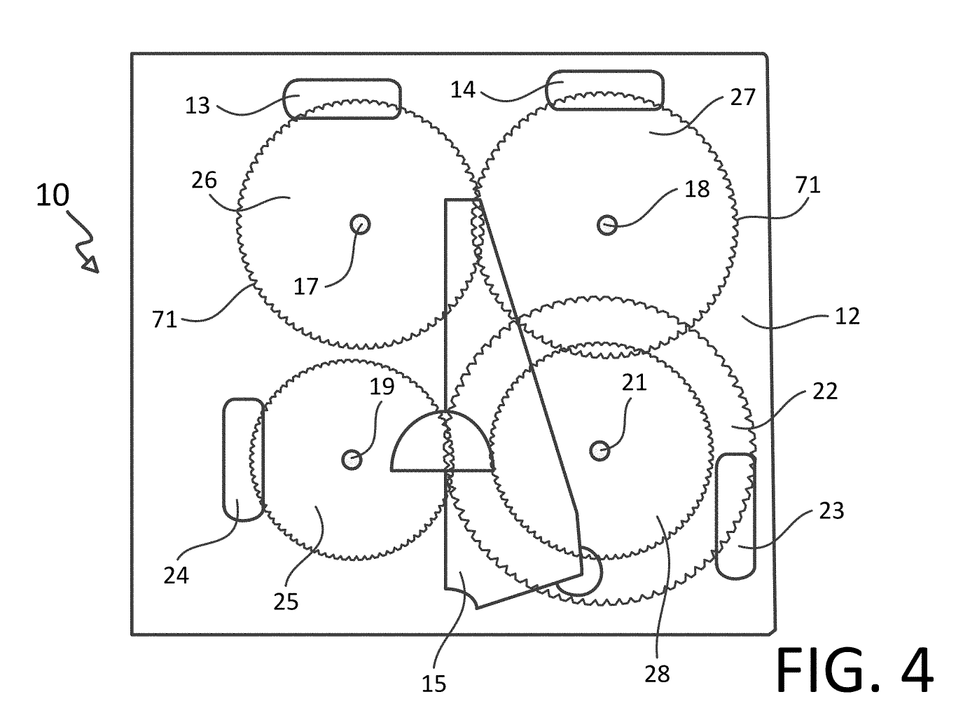

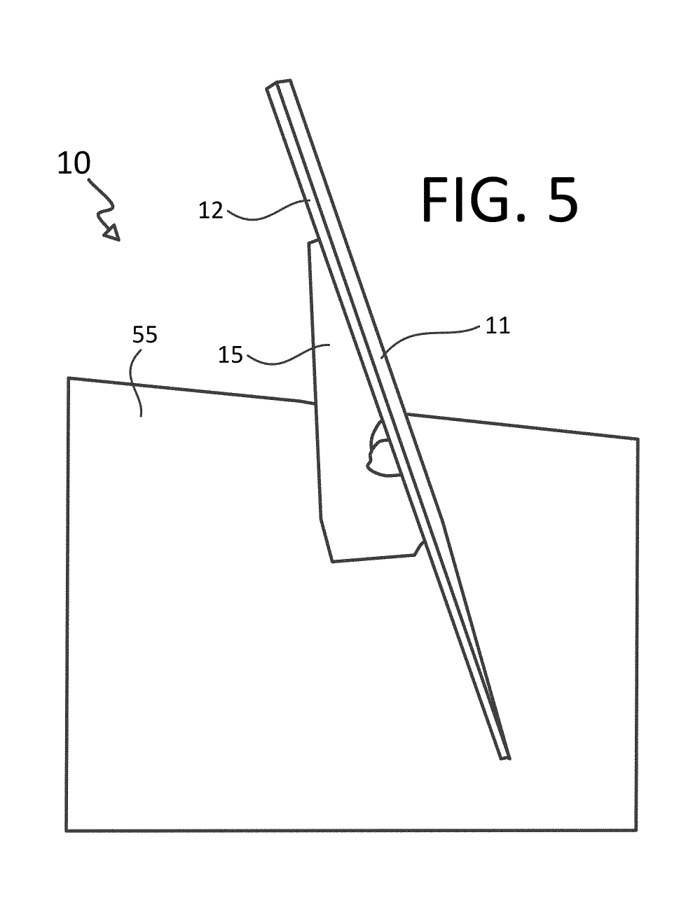

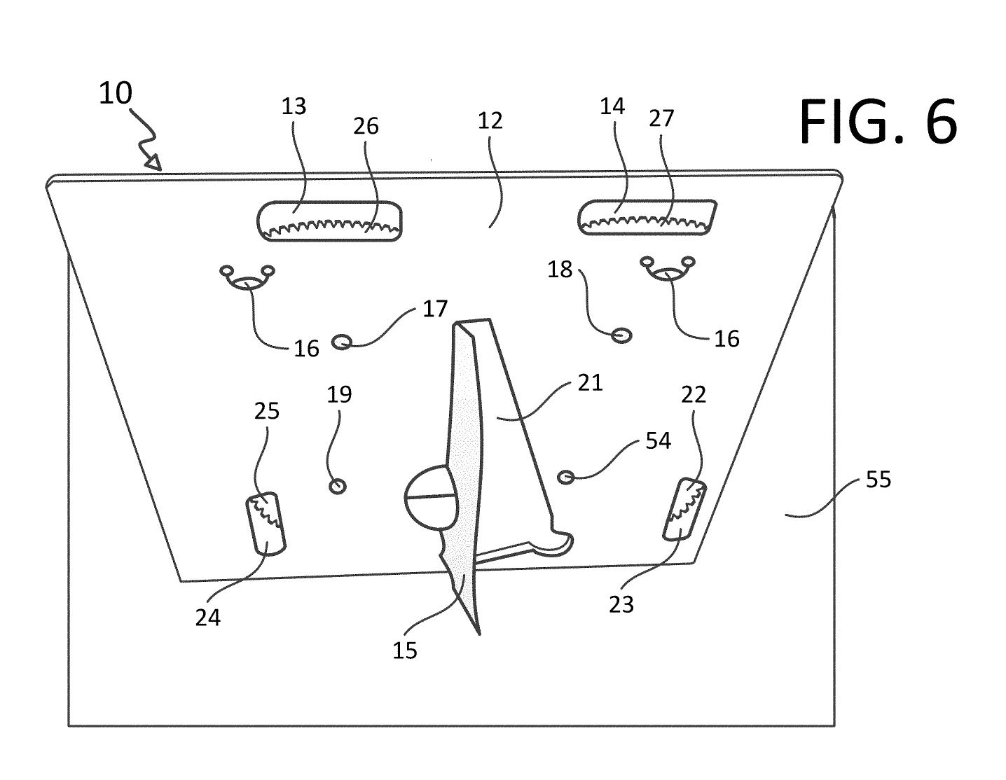

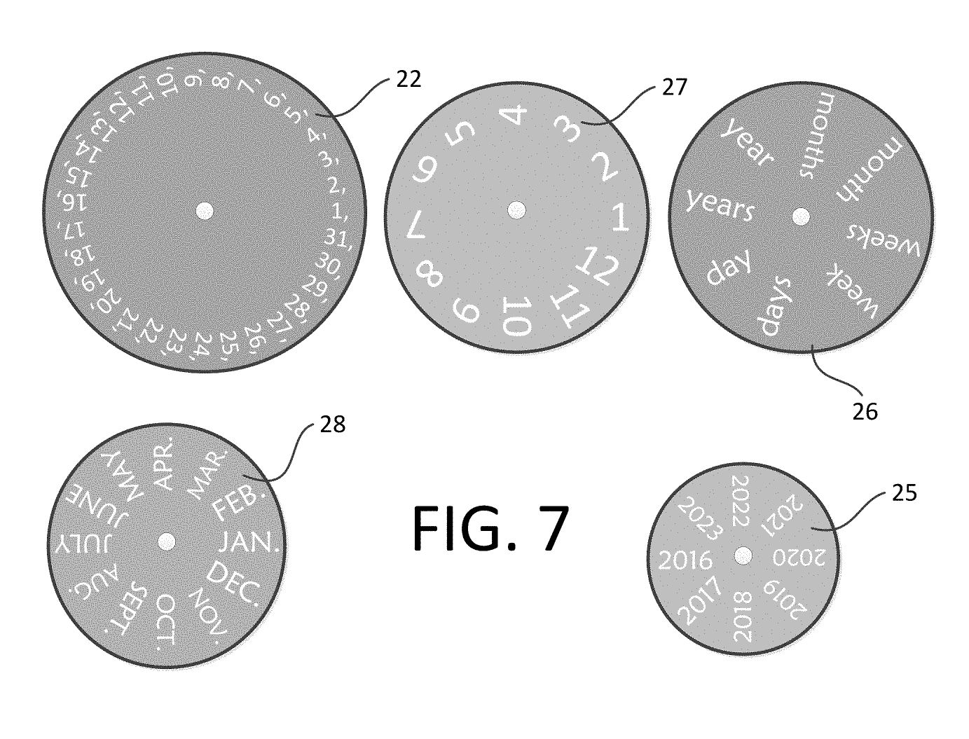

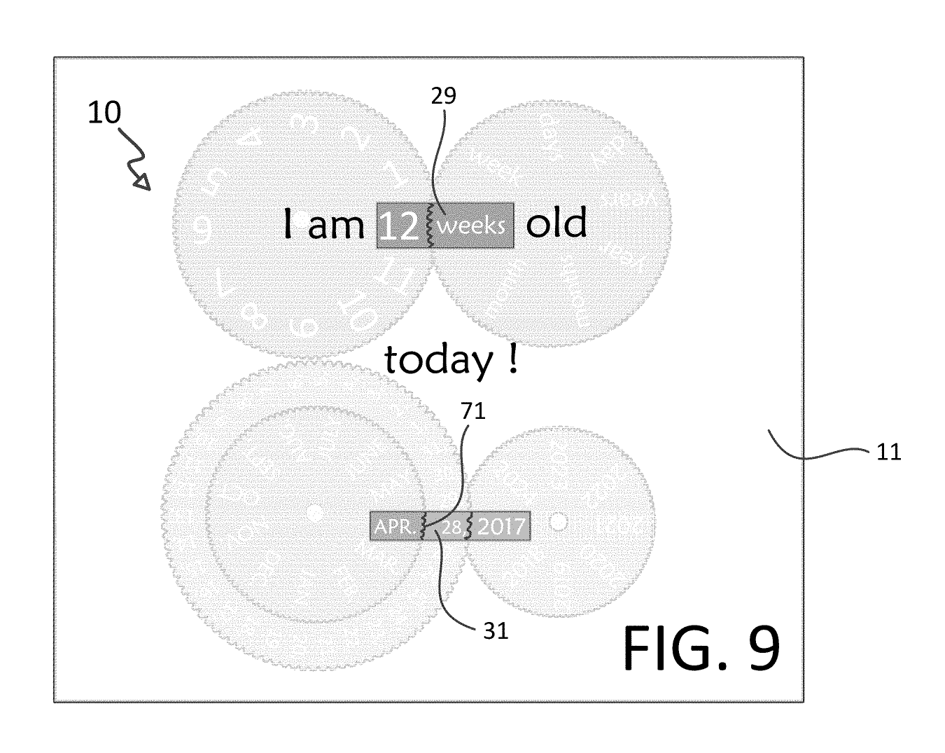

FIGS. 1-12 illustrate the present invention. FIGS. 1-8 represent the first embodiment 10 of the invention while FIGS. 9-13 represent the second embodiment 20.

In the first embodiment, the words and numbers that provide the age of the infant or toddler are printed around the perimeter of five wheels: the day of the month wheel 22, the month wheel 28, the year wheel 25, the age wheel 26, and the age number wheel 27. The months are listed around the periphery of the front surface of the month wheel 28, the day of month wheel 22 lists the numbers 1-31 on its front surface perimeter, the front surface of the year wheel 25 lists numbers sequentially from 2016 and up, the front surface periphery of the age number wheel 27 lists numbers from 1-12 and the front surface periphery of the age wheel lists, day(s), week(s), month(s) and year(s).

The wheels may be made of cardboard; however, other materials such as wood, plastic and metal also fall within the scope of the present invention. The thickness of the wheels ranges between about 0.1 to about 0.5 inches.

Each of the wheels has serrated edges 71 at their circumferences. Each of the five wheels is sandwiched between two panels: a front panel 11 and a rear panel 12. The age number wheel 27 and age wheel 26 are disposed at the top of the event board with the age wheel 26 being placed to the right of the age number wheel 27 in relation to facing the front.

The age number wheel 27 and age wheel 26 are attached to the front panel 11 and rear panel 12 by grommets 18 and 17 respectively. The grommet attachments are configured in such a way that the wheels turn when a user applies a turning force onto the edges of the wheels. This may be accomplished by applying a light turning motion onto the serrated edges 71 of the wheels using one's finger.

The day of the month wheel 22 and month wheel 28 are placed below the age number wheel 27. The month wheel 28 is superimposed over the day of the month wheel 22 such that the edge portion of the day of the month wheel 22 remains exposed and both the day of the month wheel 22 and the month wheel 28 share the same center and use the same grommet 21 to attach to the rear panel 12 and front panel 11. The year wheel 25 is placed below the age wheel 26 and attaches to the front panel 11 and rear panel 12 via grommet 19.

A foldable easel 15 is attached to the rear panel 12 of the display board. In an open position, the easel 15 supports the display board in an upright position on a flat surface 55. The easel 15 may be folded onto the rear panel 12 for stowing. Clips 16 may be used to hang the event board.

The rear panel 12 has four window cutouts that expose edges of four of the wheels. The edge of the age wheel 26 is exposed by cutout 13 at the top left of the rear panel 12. Cutout 14 on the upper right side of the rear panel 12 exposes the upper edge of the age number wheel 27. Cutout 24 on the bottom left side of the rear panel 12 exposes the bottom left edge of the year wheel 25 and cutout 23 exposes the bottom right edge of the day of the month wheel 22.

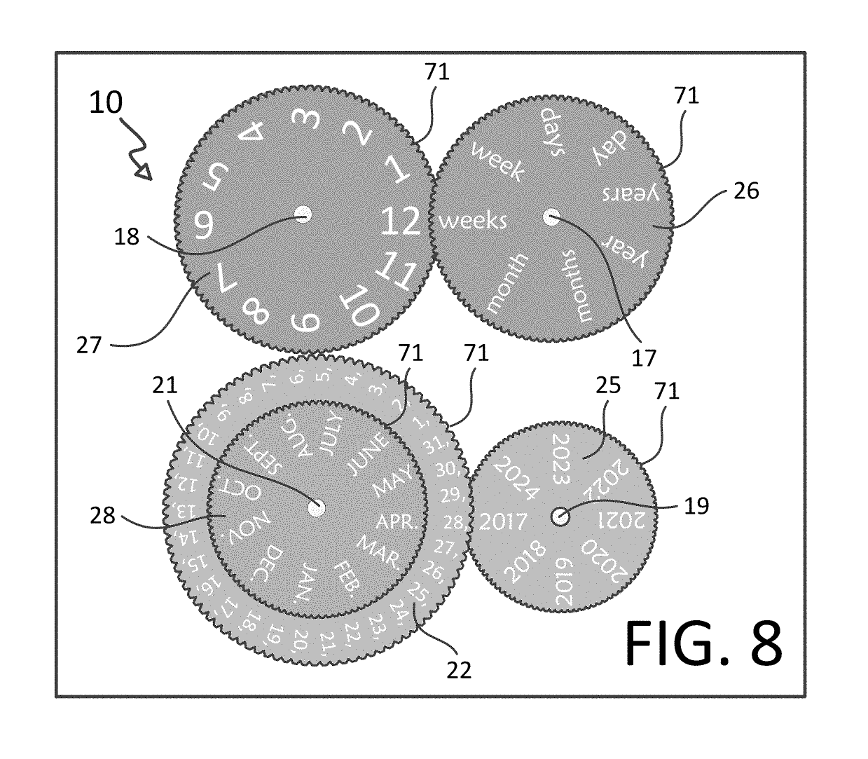

The front panel 11 has two cutouts: 1) a cutout 29 disposed at the center top of the front panel 11 and 2) a cutout 31 disposed at the bottom center of the front panel 11. The age may be displayed through cutout 29 while the date may be displayed through cutout 31. As shown in FIGS. 1, 2 and 8, the displayed age consists of a number and a time span that can be in years, months or weeks. The displayed date consists of the month (from January to December), the day of the month (from 1-31), and the year (from 2017 and higher). The front panel 11 may contain additional insignia and decorations. As can be seen in FIGS. 8 and 9, the display in the cutout window is “12 weeks” with the added permanent words “I am” before the window display and the permanent word “old” following the window display to form the phrase “I am 12 weeks old”. The word “today” is placed below the phrase.

The left edge of the age wheel 26 is superimposed over the right edge of the age number wheel 27. This allows proper alignment of the age number and age labels at the edges of the age wheel 26 and age number wheel 27 for displaying in cutout window 29. Likewise, the right edge of the day of the month wheel 22 is superimposed over the left edge of the year wheel 25 in order to achieve a continuous date display in cutout window 31 as shown in FIG. 9. It is noted that superimposing the age number wheel 27 over the age wheel 26 and superimposing the year wheel 25 over day of the month wheel 22 also fall within the scope of the present invention.

To change the displayed age number, the user would move with his/her fingers the serrated edge of the age number wheel 27 clockwise or counterclockwise inside window 14 until the desired age number is displayed in window 29. To change the displayed age, the user would move the serrated edge of age number wheel 26 clockwise or counterclockwise inside window 13 until the desired age is displayed in window 29 to the right of and in line with the age number.

To change the displayed day of the month, the user would move the serrated edge of the day of the month wheel 22 clockwise or counterclockwise inside window 23 until the desired day of the month is displayed in window 31. To change the displayed year, the user would move the serrated edge of year wheel 25 clockwise or counterclockwise inside window 24, until the desired year is displayed in window 31 to the right of and in line with the day of the month.

The month wheel 28 does not have a window in the rear panel through which the month wheel 28 may be rotated in order to change the month of the year display. Rotating the month wheel may be done by moving the edge 71 of the month wheel 28 inside window 31 disposed in the front panel 11 as shown in FIG. 9.

The dimensions of the display board and the wheels may vary to suit the needs of the users. Generally, the display board may have a length between about 1′ to about 5′ and the diameters of the wheels may range from about 0.5′ to about 3′.

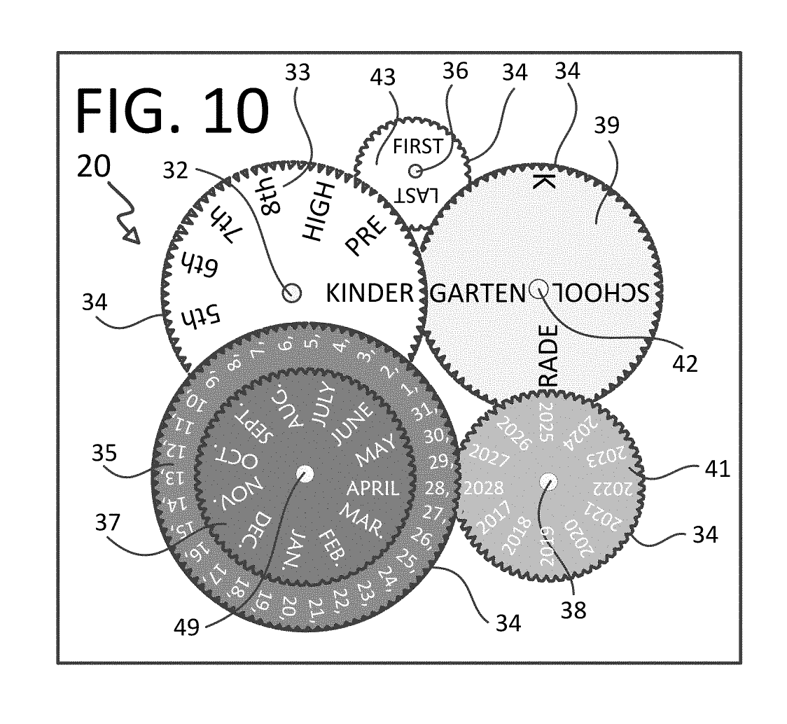

In the second embodiment shown in FIGS. 9-12, the configuration of the five wheels is similar to that of the first embodiment; however some of the labels are different. The year wheel 41 is placed to the right of the day of the month wheel 35 as shown in FIG. 10. The month wheel 37 is superimposed over a center portion of the day of the month wheel 35. As with the first embodiment, the year wheel 41 is positioned at the bottom right of the panel 51 while the day of the month wheel 35 and month wheel 37 are positioned at the bottom left of the panel 51. A grade level indictor wheel 33 is positioned at the top left of the panel 51 above the day of the month wheel 35 and a school/grade indicator wheel 39 is positioned at the top right of the panel 51 above the year wheel 41. Additionally, a sixth first/last wheel 43 is positioned above grade level indictor wheel 33 and above the school/grade indicator wheel 39 at the top center of the panel 51.

As with the first embodiment of the invention, each wheel has a center at which each wheel is attached to the front panel 51 and the rear panel 54. The center of each wheel is positioned at about a mid-point of any intersecting radius traversing the wheel. The year wheel 41 has center 38, the month wheel 37 and the day of the month wheel 35 share center 49, the school/grade indicator wheel 39 has center 42 and the grade level indictor wheel 33 has center 32. The means for attaching each wheel to the front and rear panels is a preferably a grommet; however, other means to attach the wheels to the front and rear panels also fall within the scope of the present invention.

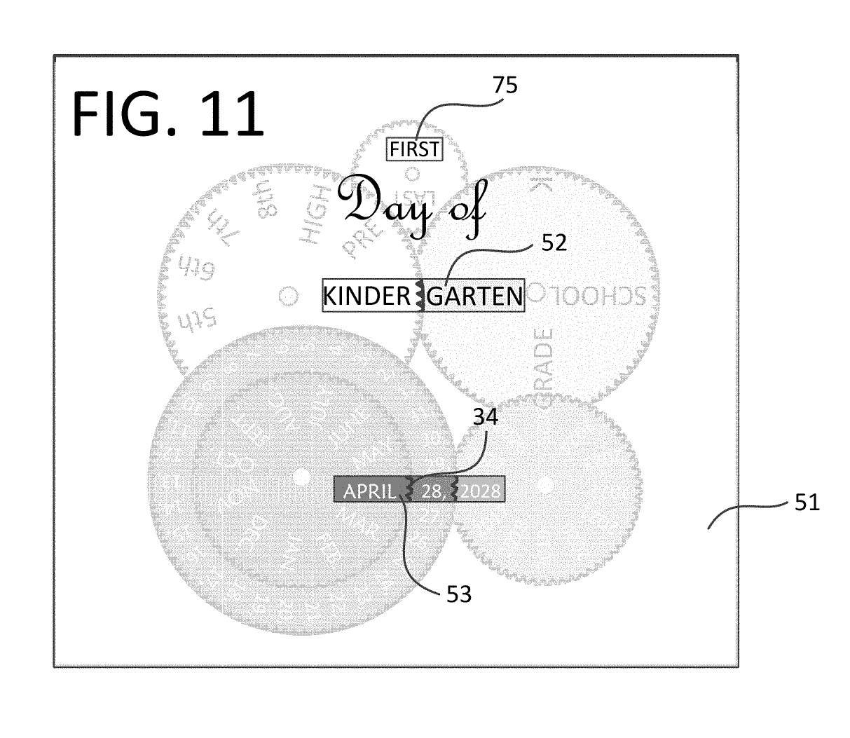

The right edge of the grade level indictor wheel 33 is superimposed over the left edge of the school/grade indicator wheel 39. This allows proper and continuous alignment of the grade level descriptor and school/grade descriptor. FIGS. 10 and 11 show an alignment between the words KINDER and GARTEN to form “KINDERGARTEN”. Other combinations can be obtained by aligning for example PRE and SCHOOOL to form the phrase “PRE SCHOOL” and “7^{th}”, and “GRADE” form “7^{th} GRADE”. This is accomplished by turning the grade level indictor wheel 33 and the school/grade indicator wheel 39 such that these word pairs are in a position of alignment as shown in cutout window 52. It is noted that superimposing wheel 39 over wheel 33 also falls within the scope of the present invention.

FIG. 11 shows the display board from the view of the front panel in a semitransparent form such that the positions of the wheels placed between the front panel 51 and the rear panel 54 can be discerned yet highlights the displays through cutout windows 52 and 53 in the front panel 51.

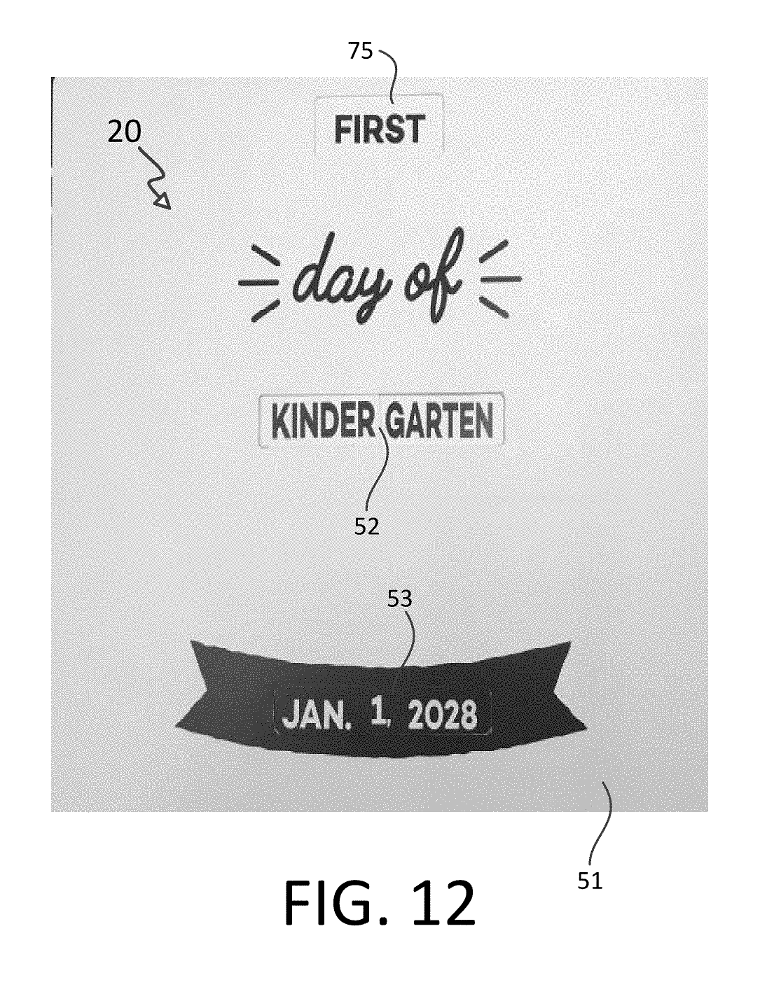

Likewise, the right edge of the day of the month wheel 37 is superimposed over the left edge of the year wheel 41 in order to achieve continuous date display in cutout window 53 as shown in FIGS. 11 and 12. It is noted that superimposing the year wheel 41 over the day of the month wheel 37 also fall within the scope of the present invention.

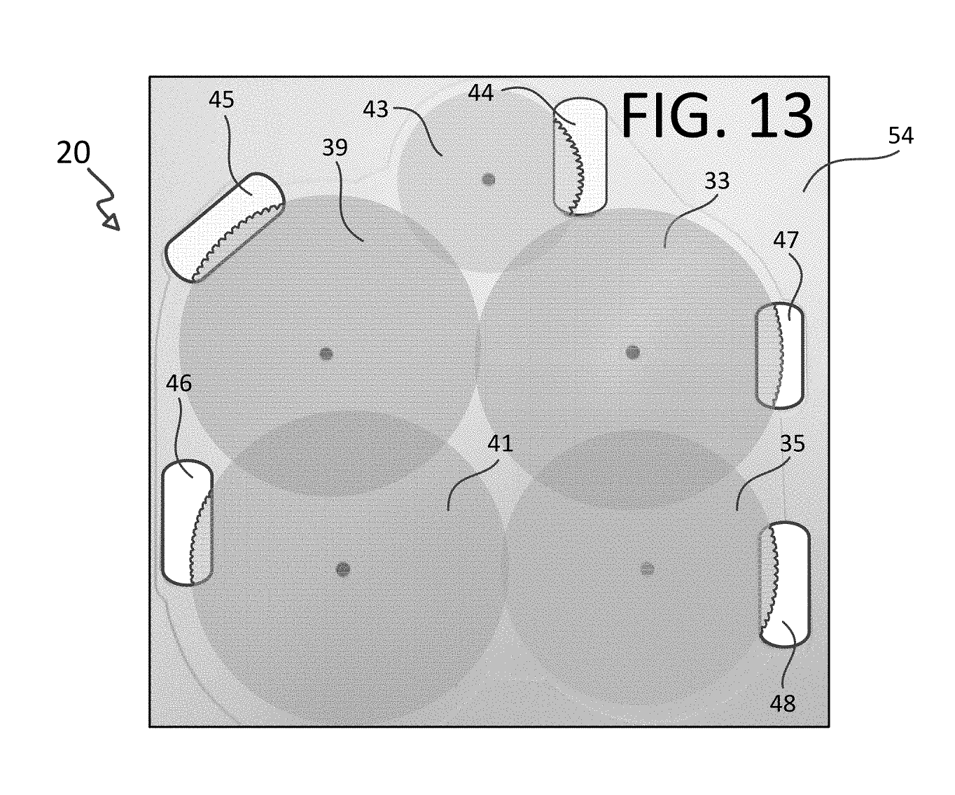

FIG. 13 shows the display board from the view of the rear panel 54 in a semitransparent form such that the positions of the wheels placed between the front panel 51 and the rear panel 54 may be discerned yet highlights the cutout windows and the serrated wheel edges visible and accessible through the respective cutout windows in the rear panel 54 for each wheel. A user may access each wheel and using one's fingers, rotate the wheels to achieve the proper wheel alignment for creating the displayed phrases.

As in the first embodiment, the wheels of the second embodiment of the present invention are attached to the front panel 51 and rear panel 54 using grommets positioned at the center of each wheel as shown in FIG. 10. The first/last wheel 43 contains grommet 36, the day of the month wheel 35 and the month wheel 37 share grommet 49, the year wheel 41 contains grommet 38, the grade level indictor wheel 33 contains grommet 32 and the school/grade indicator wheel 39 contains grommet 42. Each wheel also contains serrated edges 34 that give the users leverage to rotate the wheel using their fingers. The rear panel 54 contains cutouts through which the serrated edges of the wheels may be accessed as shown in FIG. 13. The school/grade indicator wheel 39 may be accessed through cutout window 45, the grade level indictor wheel 33 may be accessed through cutout window 47, the day of the month wheel 35 may be accessed through cutout window 48, the year wheel 41 may be accessed through cutout window 46 and the first/last wheel 43 can be accessed through cutout window 44.

The day of the month wheel 37 may be accessed through cutout 53 in the front panel 51. The sixth wheel 43 may provide additional descriptors to the display board 20. As depicted in FIG. 10, the first/last wheel 43 may be toggled between the words LAST or FIRST. The combination of KINDER and GARTEN can be viewed in the cutout window 52 in the front panel 51. The label on the first/last wheel 43 can be seen through cutout window 75 in the front panel 51 as shown in FIGS. 11 and 12.

It is noted that the front panel 51 may contain additional writings and decorative insignia as shown in FIG. 12.

It should be understood, of course, that the foregoing relates to exemplary embodiments of the invention and that modifications may be made without departing from the spirit and scope of the invention.

We claim:

1. A board for displaying events, said board comprising:
a front panel;
a rear panel; and
a wheel assembly containing a plurality of wheels disposed between the front panel and the rear panel, said each wheel being attached to the front panel and a rear panel at a center of said each wheel, said each wheel being configured to rotate around said center.

2. The board of claim 1, wherein a front surface of each wheel contains a plurality of event descriptors.

3. The board of claim 1, wherein a circumference edge of each wheel contains serrations.

4. The board of claim 3, wherein the wheel assembly contains:
a first wheel disposed at an upper left side of the board, said first wheel containing labels placed on a front surface of said first wheel, wherein a portion of the labels placed on the first wheel are located at a circumference of the first wheel front surface;
a second wheel disposed at an upper right side of the board, said second wheel containing labels disposed at a front surface of said second wheel, wherein a portion of the labels placed on the second wheel are located at a circumference of the second wheel front surface;
a third wheel disposed at a lower left side of the board, said third wheel containing labels disposed at a front surface of said third wheel, wherein a portion of the labels placed on the third wheel are located at a circumference of the third wheel front surface;
a fourth wheel disposed at a lower right side of the board, said fourth wheel containing labels at a front side of the fourth wheel, wherein a portion of the labels placed on the fourth wheel are located at a circumference of the fourth wheel front surface; and
a fifth wheel superimposed over a center portion of the third wheel in such a manner that a circumference portion of the third wheel remains exposed, said fifth wheel containing labels at a front side of the fifth wheel, wherein a portion of the labels placed on the fifth wheel are located at a circumference of the fifth wheel front surface, said fifth wheel being configured to rotate independently of the third wheel, said center of the fifth wheel being superimposed over the center of the third wheel.

5. The board of claim 4, wherein the first wheel is disposed in a vertical plane positioned behind a vertical plane of the second wheel in a way that a portion of a left side of the second wheel overlaps over onto a portion of a right side of the first wheel.

6. The board of claim 4, wherein the fourth wheel is disposed in a vertical plane that is positioned behind a vertical plane of the third wheel in a way that a portion of a right side of the third wheel overlaps over onto a portion of a left side of the fourth wheel.

7. The board of claim 5, further comprising:
a first opening in the rear panel, said first opening being disposed over a circumference edge portion of the first wheel in a manner as to expose the serrations on said circumference edge portion of the first wheel;
a second opening in the rear panel, said second opening being disposed over a circumference edge of the second wheel in a manner as to expose the serrations on the circumference edge portion of the second wheel;
a third opening in the rear panel, said third opening being disposed over a circumference edge portion of the third wheel in a manner as to expose the serrations on said circumference edge portion of the third wheel; and
a fourth opening in the rear panel, said fourth opening being disposed over a circumference edge portion of the fourth wheel in a manner as to expose the serrations on said circumference edge portion of the fourth wheel.

8. The board of claim 5, further comprising:
a fifth opening in the front panel, said fifth opening being disposed over an overlapping portion of the first wheel and the second wheel in a manner as to expose for view labels placed on the first wheel located at a circumference of the first wheel front surface and expose for view labels placed on the second wheel located at a circumference of the first wheel front surface, said fifth opening also being disposed over a circumference portion of the fifth wheel in a manner as to expose for view labels placed on said circumference portion of the fifth wheel.

9. The board of claim 4, further comprising a sixth wheel substantially disposed vertically above the first board and the second board, said sixth wheel containing labels at a front side of the sixth wheel.

10. The board of claim 9, further comprising a fifth opening in the rear panel, said fifth opening being disposed over the circumference edge portion of the sixth wheel in a manner as to expose the serrations on the circumference edge portion of the sixth wheel.

11. The board of claim 1 further comprising a support for placing the board in an upright position.

12. The board of claim 1 wherein attachment of each wheel to the front panel and the rear panel at the center of each wheel is accomplished using a grommet.

13. A method for setting up and displaying an event board comprising:
providing a board containing a front panel, a rear panel and a wheel assembly containing; a first wheel disposed at an upper left side of the board, said first wheel containing labels placed on a front surface of said first wheel, wherein a portion of the labels placed on the first wheel are located at a circumference of the first wheel front surface; a second wheel disposed at an upper right side of the board, said second wheel containing labels disposed at a front surface of said second wheel, wherein a portion of the labels placed on the second wheel are located at a circumference of the second wheel front surface; a third wheel disposed at a lower left side of the board, said third wheel containing labels disposed at a front surface of said third wheel, wherein a portion of the labels placed on the third wheel are located at a circumference of the third wheel front surface; a fourth wheel disposed at a lower right side of the board, said fourth wheel containing labels at a front side of the fourth wheel, wherein a portion of the labels placed on the fourth wheel are located at a circumference of the fourth wheel front surface; and a fifth wheel superimposed over a center portion of the third wheel, said fifth wheel containing labels at a front side of the fifth wheel, wherein a portion of the labels placed on the fifth wheel are located at a circumference of the fifth wheel front surface, said fifth wheel being configured to rotate independently of the third wheel, said each wheel being attached to the front panel and a rear panel at a center, said each wheel being configured to rotate around said center;
rotating the first wheel and the second wheel in such a manner as to arrange the labels on the first wheel to align with corresponding labels on the second wheel;
rotating the third wheel and the fourth wheel in such a manner as to arrange the labels on the third wheel to align with corresponding labels on the fourth wheel; and
rotating the fifth wheel in such a manner as to arrange the labels on the fifth wheel to align with corresponding labels on the third wheel.

14. The method of claim 13, wherein rotating each wheel is accomplished by applying a turning motion onto serrated edges disposed on the circumference of each wheel by a user's fingers.

15. The method of claim 13, wherein access to each wheel for applying a turning motion onto serrated edges of each wheel is through an opening in the rear board disposed behind said each wheel.

16. The method of claim 13, further comprising rotating a sixth wheel disposed above the first and second wheel in a manner as to position labels on said sixth wheel in a position for viewing through a sixth opening in the front panel.

17. The method of claim 16, wherein rotating the sixth wheel is accomplished by applying a turning motion onto serrated edges disposed on the circumference of the sixth wheel, said serrated edges disposed on the circumference of the sixth wheel being accessible through an opening in the rear panel disposed over a circumference edge of the second wheel.
